(19) United States
(12) Patent Application Publication
(10) Pub. No.: US 2012/0186273 A1
(43) Pub. Date: Jul. 26, 2012

(54) Produce Refrigeration Chamber

(76) Inventors: Vincent Arrigo, Sarasota, FL (US); Glenn Akhavein, Bradenton, FL (US); Richard T. Herbst, JR., Bradenton, FL (US); Robert Brady, Sarasota, FL (US)

(21) Appl. No.: 13/013,327

(22) Filed: Jan. 25, 2011

(51) Int. Cl. F25B 21/02; F25D 11/00; B01D 53/02; F25D 23/02

(52) U.S. Cl. 62/3.6; 62/449

(57) ABSTRACT

The invention is directed to a produce chamber having an outer housing with a first panel, a second panel, and a base plate inter-dispersed between both panels. A door is placed between both panels to deposit and remove produce. Positioned within the first panel is a refrigeration system, which includes both ammonium absorption (AAF) system and a Peltier thermoelectric plate (TE) system. The AAF system includes a contact plate which communicates with a series of ducts having a first and second channel. The first channel circulates ammonia, while the second draws and then cools outside air for introduction into the produce chamber. The TE system is positioned proximate the contact plate to afford additional cooling, which has a plurality of parallel thermoelectric plates. A digital controller operates both the AAAF and TEC systems. Such controller also operates a scrubber, which includes zeolite powder, to remove ethylene.

### FIELD OF THE INVENTION

The present invention relates to an electric powered chamber to store fruits, vegetables and other food items at regulated temperatures. More specifically, the invention teaches a portable kitchen countertop electric that uses combination of ammonium absorption (AAF) and Peltier effect thermoelectric refrigeration (TE) to efficiently cool produce to allow longer storage for later consumption.

### BACKGROUND OF INVENTION

Fruits and vegetables have long been an important component of the human diet. Based upon their various nutrients and antitoxins, consumption of fresh produce helps provide important vitamins and nutrients to the human body. For example, fruits are typically high in fiber, water, vitamin C, and phytochemicals necessary for proper long-term cellular health and disease prevention.

Regular consumption of fruit is associated with reduced risks of cancer, cardiovascular disease (especially coronary heart disease), stroke, Alzheimer disease, cataracts, and some of the functional declines associated with aging. Diets that include a sufficient amount of potassium from fruits and vegetables also help reduce the chance of developing kidney stones and may help reduce the effects of bone-loss. Fruits are also low in calories which would help lower ones calorie intake as part of a weight loss diet.

Both fruits and vegetables ripen after they are removed from their associated plants and stalks. Such ripening often helps change the characteristics of the produce, including the sweetening of the fruit as well as changes in texture and firmness. Consumption of fruits and vegetables at the optimal point in the ripening process helps maximize not only taste and enjoyment of these foods, but also their health benefits. Ripening is the natural result of ethylene released by the produce. Maintaining most fruits and vegetables in an efficient cold chain after harvest helps extends and ensures shelf life—by reducing release of ethylene. However, storage of produce in an isolated area without refrigeration causes build up of ethylene and faster ripening (and resulting rotting) of fruit.

Due to the costs and life spans of harvested fruits and vegetables, there have been many devices developed to address storage to maintain this cold chain. One such example is U.S. Pat. No. 4,845,958 entitled “Method of and Apparatus for Preserving Perishable Goods” to Senda. The apparatus taught by Senda relates to a refrigerated housing that includes a humidifier and a compression system to cool the housing. The device also uses an ethyl alcohol spray to help odorize the ripening produce.

A second concept for preserving ripening produce is U.S. Pat. No. 5,661,979 entitled “Self-contained Refrigeration Device for Fruit” to Deboer. The Deboer patent teaches a self contained refrigeration unit that uses thermo-electric (TE) chips, as well as a heat sink to dissipate the heat generated by the TEC chips—to afford a cooled container which maintains the fruit. A double headed fan facilitates airflow throughout the assembly, to help remove ethylene through a vent tower.

Yet a third example of a system for preserving fruit and vegetables is U.S. Pat. No. 5,782,094 entitled “Refrigerated Countertop Snack Container” to Freeman. Akin to Daboer, Freeman uses a Peltier effect thermoelectric element (instead of a compressor) to cool a refrigeration container. Such container is insulated and includes a series of air outlet and intake vents to aide in circulating air about the various snacks in order to reduce ethylene build up. The device further uses a series of fins to aide in circulation, as well as related baffles.

As shown by the foregoing references, there are certain limitations in current counter-top style devices used to maintain fruits and vegetables. First, these devices are limited to using the Peltier effect (or traditional vapor compression systems) in combination with airflow to ward off the effects of build up. Second, current designs are largely inefficient and consume large levels of energy. Lastly, most of these designs fail to provide effective treatment of the ethylene which is the root of rotting and spoilage of the produce. Accordingly, there is a need in the art of produce storage for an energy efficient and robust chamber for use with fresh fruits and vegetables.

### SUMMARY OF THE INVENTION

The forgoing invention solves many of the limitations found in current produce storage devices. The invention is directed to a produce chamber capable of storing and maintaining a variety of fruits and vegetables at a controlled temperature, humidity and level of ethylene concentration. Such produce chamber may be configured to be a countertop appliance, and optionally can be modular such that they can be stacked for use in retail establishments like a grocer. Such stacking allows compact display of various produce allowing optimum ripeness and freshness. Additionally, the produce chamber is scalable so that a single unit could be designed to work as a countertop appliance and much larger single units could be designed for grocery stores.

Such produce chamber comprises an outer housing having a first panel, a second panel, and a base plate inter-dispersed between both the first and second panels. The first panel includes a circular disk having a ring, a first wall, and a flat bottom portion which mirrors the width of the base plate. Preferably, such first panel may also include a series of vents capable of cooling the refrigeration system. Positioned between both panels is a door (which may translucent) having a handle. Through use of a top hinge, the door is capable of opening to allow placement and removal of produce. A two-part refrigeration system may be positioned within the first panel. Such refrigeration system may include combination of both an ammonium absorption (AAF) system and a Peltier effect thermoelectric (TE) system.

The ammonium absorption (AAF) system includes an self contained ammonia water solution and a heat source. It has no moving parts and only requires a heat source to make the system work. The system has ammonia, a boiler, condenser, evaporator, storage tank, and an absorber. The evaporator sits on the inside of the unit and a fan directs air over it to cool the product chamber, and the balance of the system is located on the outside of the unit.

The Peltier effect thermoelectric (TE) can be used as the refrigeration system for the produce chamber. Such thermoelectric (TE) system may include a plurality of thermoelectric modules in parallel relation to one another, laying side by side, or in series relation, stacked on top of one another. These modules have a heat sink on each side of them and a fan on each heat sink to improve their efficiency. The side of the plate that gets cool and its heat sink and fan are substantially inside the produce chamber, and the hot side of the plate and its heat sink and fan are substantially outside of the produce chamber. The produce chamber can use an AAF, a TE, or a combination of AAF and TE refrigeration systems to cool the air inside of the unit.

Apart from the refrigeration system, the first panel may also include a scrubber capable of removing ethylene and a humidity regulator to prevent premature ripeness of the produce. Such scrubber may include a quantity of crystalline zeolite powder for purposes of removing ethylene from the air within the produce chamber. The last component of the produce chamber is a digital controller capable of operating the refrigeration system, as well as the scrubber sufficient to remove ethylene from the chamber. The controller may also read the humidity and the internal temperature. The controller may include a digital read out, which displays this information and provides updates to the user (U).

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a perspective view of the produce chamber;

FIG. 2 is a right side view of the produce chamber;

FIG. 3 is a left side view of the produce chamber;

FIG. 4 is front view of the produce chamber;

FIG. 5 is an exploded view of the components of the produce chamber;

FIG. 6 is a perspective view of the refrigeration system within the produce chamber; and

FIG. 7 illustrates the preferred thermoelectric plate (TE) used within the produce chamber.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

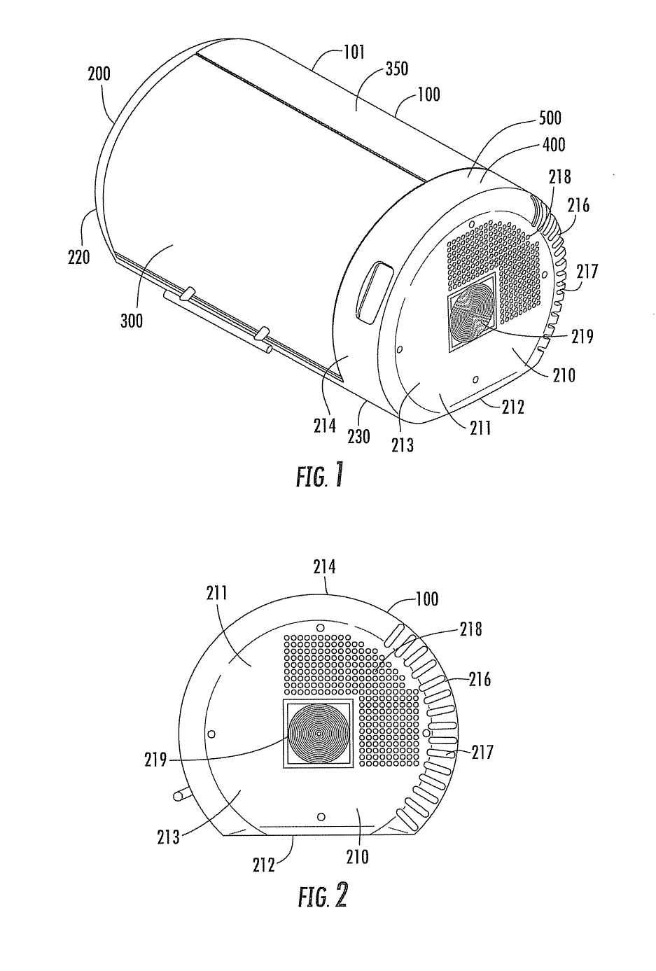

As illustrated in FIGS. 1-6, the invention is directed to a produce chamber 100 used to store fruits, vegetables other related perishable foods to ensure ripeness. The produce chamber 100 helps regulate the temperature and humidity of fruits and vegetables and to ensure regulated and reduced levels of ethylene. In doing so, the produce chamber 100 helps maintain the proper ripeness of this produce after purchase from the store. While the invention contemplates a design for use on a kitchen countertop, the underlying technology can be used in related units, including produce chambers 100 that are stackable (i.e., for use as displays at grocers to maintain fruits and vegetables), and produce chamber 100 that are equal in size to current grocery store refrigeration units.

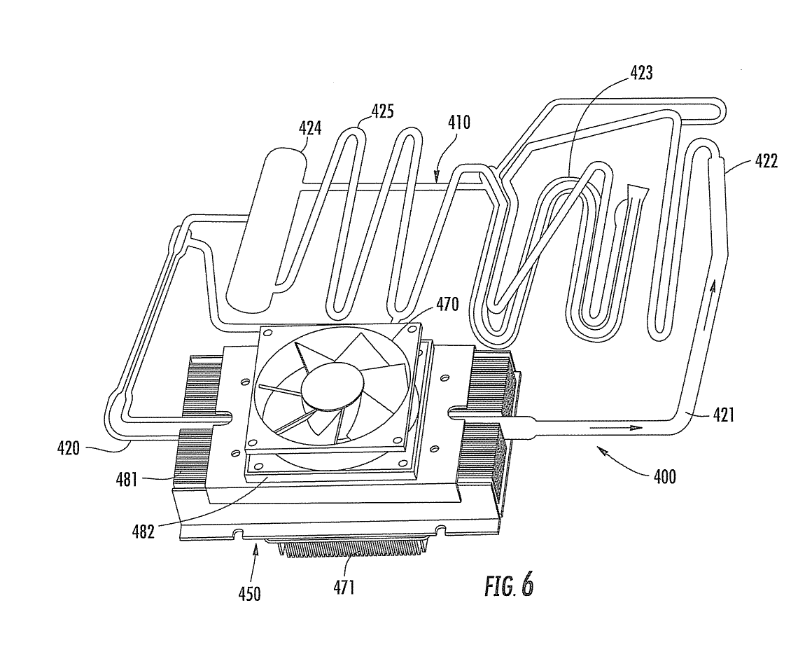

As shown in FIG. 5, the components 101 of the produce chamber 100 comprises an outer housing 200, a door 300 maintained by the outer housing 200, a refrigeration system 400 and a controller 500 to help regulate temperature, humidity and ethylene concentration. In addition, the invention contemplates placement of a series of perforated trays 600 and a hook 630 within the outer housing 200 which help hold and maintain the stored produce. Other additional and related components 101 will be known and understood by those of ordinary skill in the art upon review of the figures and this disclosure.

### The Outer Housing

FIGS. 1 through 5 illustrate, by way of example, one embodiment contemplated by the invention for the outer housing 200. First turning to FIG. 1, the outer housing 200 may include a first side panel 210, a second side panel 220 and a base plate 230 (shown in greater detail in FIG. 5). The side panels 210 and 220 are essentially parallel to one another in order to form two respective ends of the produce chamber 100. The base plate 230 is inter-dispersed between both side panels 210 and 220. Combination of these panels 210 and 220, as well as the base plate 230 function as the outer casing of the outer housing 200. This provides a rigid shell for the outer housing 200 in order to protect the integrity of the stored fruits and vegetables. What is more, such rigid shell further serves as a platform in which the various interior components 101 (shown in FIG. 5) are maintained and held within the produce chamber 100.

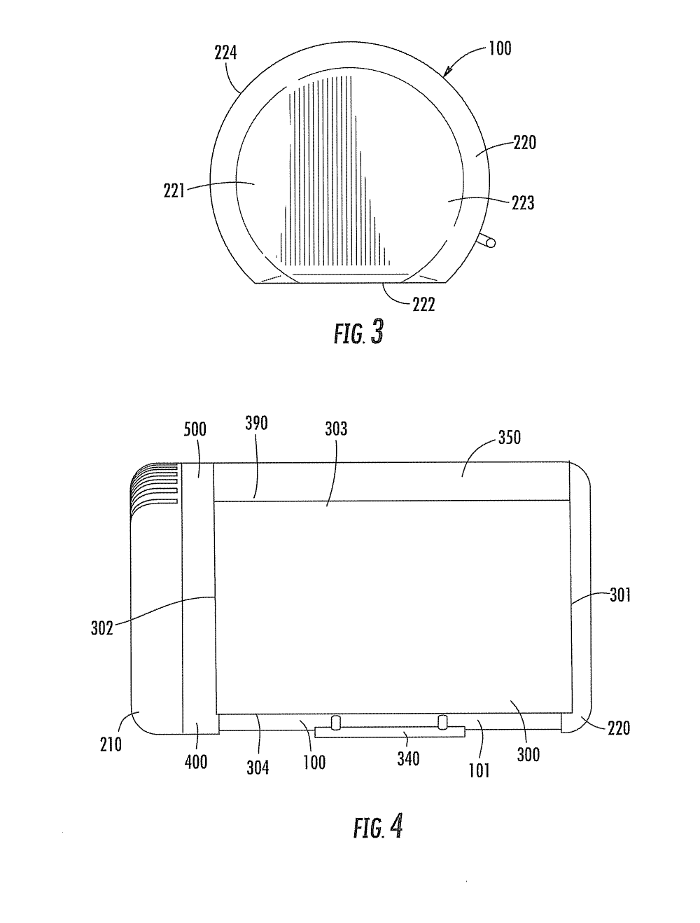

FIG. 2 further illustrates one preferred shape, structure and configuration for the first side panel 210. The first side panel 210 not only functions as part of the rigid outer housing 200, but also maintains two primary components 101 of the produce chamber 100. As shown in FIG. 2 (as well as FIG. 5), the first side panel 210 has a sufficient shape to house both the refrigeration system 400 and the controller 500. The first panel 210 further allows for the separation of the cold and hot sides of the refrigeration system 400 as well as to cool the various components 101 housed by the first panel 210. Moreover, this allows circulation of cooled and humidity controlled air inside the produce chamber 100 for purposes of removing ethylene.

As shown in both FIG. 1 and FIG. 2, the first panel 210 is preferably a circular disk 211 having an essentially flat bottom portion 212. The bottom portion 212 illustrated in FIG. 2 mirrors the width of the base plate 230 (shown in FIG. 4). As also shown in FIG. 5, the base plate 230 perpendicularly engages the first flat wall 213 of the first side panel 210. This allows the bottom portion 212, and accordingly the entire produce chamber 100, to rest on a flat surface like a kitchen countertop—or alternatively a display counter (such as in a grocery store).

Turning back to FIG. 1 (and also to FIG. 4), the structure of the first panel 210 also includes a first ring 214 (in addition to the first flat wall 213 and the bottom portion 212). The first ring 214 is essentially circular, conforming to the shape of the bottom portion 212. Moreover, the first ring 214 has a sufficient wall thickness so as to house and maintain the various components 101—which may include both the refrigeration system 400 and the controller 500.

As shown in both FIG. 1 and FIG. 2, both the first flat wall 213 and the first ring 214 may include a series of vents 216. As shown, these vents 216 preferably include a side vent 217, a panel vent 218 and a fan vent 219. As shown in greater detail in FIG. 5, the primary function of the side vent 217 and the panel vent 218 is to allow the hot side heat sink fan 482 (shown in FIG. 7) to pull ambient air in through the side vent 217 and the panel vent 218, move it across the hot side heat sink 481 and then push the now hot air out through fan vent 219 so as to remove heat from the refrigeration system 400. The secondary purpose is to pull ambient air in through the side vent 217 and panel vent 218 to cool the controller 500.

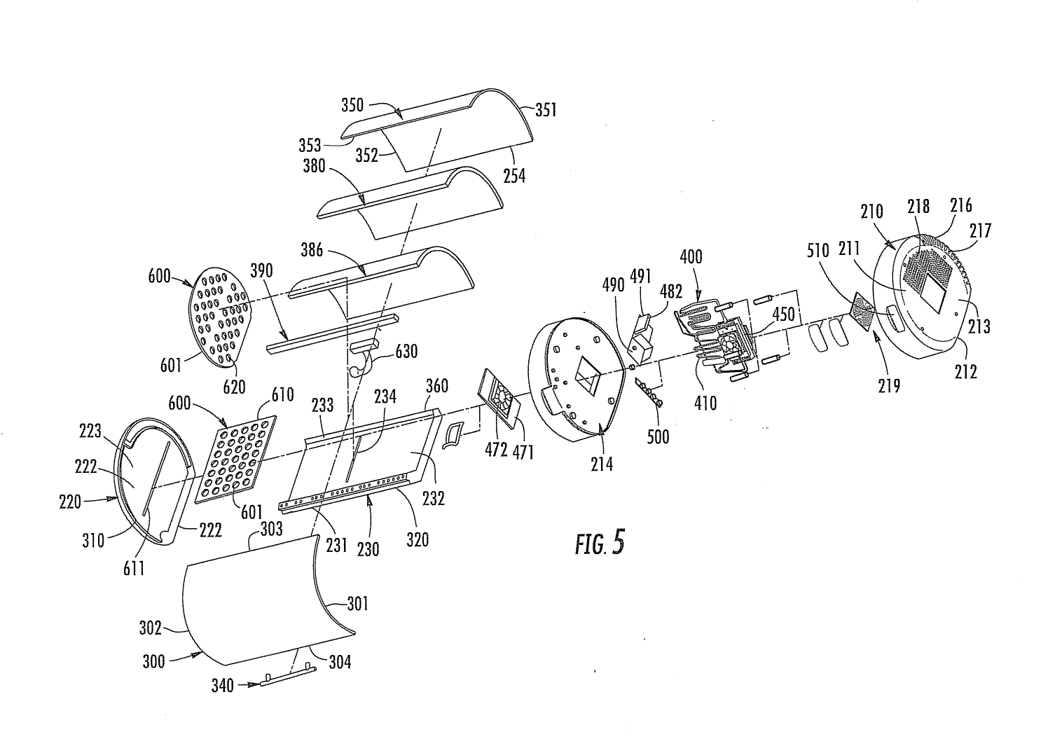

Both FIG. 3 and FIG. 5 illustrate, by way of example, the structure, positioning and features of the second panel 220. As shown, the second panel 220 mirrors the size and dimension of the first panel 210. Furthermore, the second panel 220 comprises a circular disk 221 having a second flat wall 223, a second flat bottom portion 222, and a second ring 224 of similar construction compared to the first panel 210. Such bottom portion 222 mirrors the width of the base plate 230 (again shown in FIG. 1 and FIG. 5).

Further shown in FIG. 1, this second panel 220 is essentially in parallel relation to the first panel 210. However, the second panel 220 does not include a set of vents 216 nor does it maintain any portion of the refrigeration system 400 or the controller 500.

FIG. 5 illustrates, by way of example, the structure and features of the base plate 230. As shown, the base plate 230 preferably includes a front raised edge 231, a bottom panel 232, a back raised edge 233 and a divider groove 234. The front raised edge helps engage and creating a sealing relationship with the door 300. Similarly, the back raised edge 233 both meets and connects to the back panel 350. The divider groove 235 is a slit that has a sufficient length and depth so as to engage and maintain one or more perforated trays 600.

### The Door and Back Panel

Both FIG. 4 and FIG. 5 illustrate, by way of example, the structure and characteristics of both the door 300 (which optionally may be translucent) and the back panel 350 which, along with the outer housing 200, form the exterior of the produce chamber 100. First turning to FIG. 4, the door 300 includes a first edge 301, a corresponding second edge 302, a top edge 303 and a corresponding bottom edge 304. Moreover, at least a portion of the door 300 is preferably transparent and accordingly “see through”—such that a user (U) may be able to view the condition and quantity of fruits and vegetables within the produce chamber 100. Preferably, a handle 340 is positioned proximate the bottom edge 304 of the door 300. The handle 340 helps make it easier to lift up and open the door 300 to retrieve (or alternative store) produce.

As shown in FIG. 5, the first edge 301 of the door 300 is preferably arced. This curvature should be substantially same as that of the first ring 214 of the first panel 210. Likewise, the second edge 302 should have curve that mirrors that of the second ring 224 of the second panel 220. Accordingly, when the door 300 is shut, a seal 310 forms between the first edge 301 and the first ring 214 (and correspondingly, the second edge 302 and the second ring 224). In addition, the bottom edge 304 forms a bottom seal 320 with the front raised edge 231 of the base plate 230.

FIG. 5 further illustrates, by way of example, the salient components 101 of the back panel 350. As shown, the back panel 350 includes a first edge 351, a corresponding second edge 352, a top edge 353, and a bottom edge 354. The first edge 351 is sufficiently curved to match the shape of the first panel 210, while the second edge 352 is likewise arced to mirror the diameter of the second panel 220. As further shown, the bottom edge 354 forms a bottom seal 360 with the back raised edge 233 of the bottom plate 230.

A top hinge 390 connects the top edge 301 of the door 300 with the top edge 351 of the back panel 350. As shown, the top hinge 390 allows the door 300 to swivel open and expose the various fruits and vegetables within the produce chamber 100. Optionally, the back panel 350 may include an insulating layer 380. This insulating layer can be sandwiched between the back panel 350 and an interior panel 385. Such insulating layer 380 increases the efficiency of the system and reduces the need for the refrigeration system 400 to constantly run to provide cooled air within the produce chamber 100.

### Perforated Trays

FIG. 5 further illustrates, by way of example, the positioning and orientation of the perforated trays 600 within the produce chamber 100. As shown, the perforated trays 600 preferably include a horizontal tray 610 and a corresponding vertical tray 620. Both trays 610 and 620 include a plurality of holes 601 to allow air to circulate. This helps ensure the reduction of ethylene within the produce chamber 100, as well as a regulated internal temperature monitored by the controller 500.

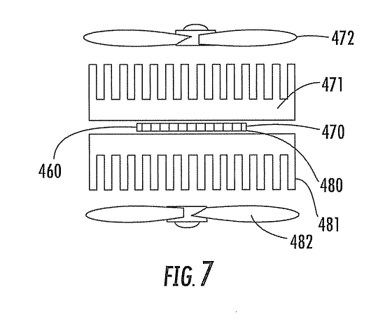

As further shown in FIG. 6, the horizontal tray 610 is maintained through a slit 611 found within the second panel 220. In contrast, the vertical tray 620 is maintained by both the horizontal tray 610 as well as the divider groove 234 located on the base plate 230. Optionally, a hook 630 can be affixed to the top hinge 390 sufficient to hold and maintain bananas and similar fruits within the produce chamber 100.

### The Refrigeration System

Both FIG. 5 and FIG. 6 illustrate, by way of example, one embodiment of the refrigeration system 400. While several refrigeration systems 400 are capable of being used within the produce chamber 100, the invention specifically contemplates combination of both an ammonium absorption (AAF) system 410 as well as a Peltier effect thermoelectric (TE) system 450. While FIG. 5 illustrates this two-part refrigeration system 400, the invention also teaches use of just a single AAF system 410 without need for the TE system 450 or use of a single TE system 450 without the need for an AAF system 410.

Both FIG. 5 and FIG. 7 illustrate a TE system 450 generally comprised of a thermoelectric (TE) module 460 which is comprised of a cold side plate 470 and a hot side plate 480 and corresponding cold side heat sink 471 and cold side heat sink fan 472 and hot side heat sink 481 and hot side heat sink fan 482. When electricity is applied to the TE module 460 the cold side plate 470 cools down and the hot side plate 480 heats up. A cold side heat sink 471 is thermally coupled to the cold side plate 470 which allows heat to be efficiently transferred from the inside of the produce chamber 100 to the cold side plate 470. A cold side heat sink fan 472 increases the efficiency of the entire system. The cold side heat sink fan 472 also works to keep the air within the produce chamber 100 moving through the zeolite filter 491.

As further shown in FIG. 7, the heat that is being absorbed by the cold side plate 470 is being transferred to the hot side plate 480. This heat is transferred through the thermally coupled hot side heat sink 481 which located outside of the produce chamber 100. The hot side heat sink fan 482 is used to efficiently remove the heat from the hot side heat sink 481. This heat is vented out through the fan vent 219.

FIG. 5 illustrates a AAF system 410 comprised of a boiler 420, ammonia 421, a condenser 422, an evaporator 423, a storage tank 424, and an absorber 425. A concentrated ammonia solution 421 is heated in the boiler 420 and driven off as vapor. The pressurized ammonia 421 gas is then liquefied in a condenser 422. Supplied with hydrogen, it evaporates in the evaporator 423 and extracts heat from the storage container 424. The ammonia 421 gas then enters the absorber 425 where it is reabsorbed in a weak solution of ammonia 421. Finally, the saturated solution flows back to the boiler 420 where the whole cycle starts again.

FIG. 6 illustrates one arrangement for the various components 101 of the two-part refrigeration system. Since the TE system 450 cools the produce chamber 100 by extracting heat from it. This heat must ultimately be removed from the entire produce chamber 100. In turn, the AAF system 410 starts by heating ammonia 421 in the boiler 420. The boiler 420 can be heated by any number of means; all that matters is that heat is provided to the boiler 420. The invention specifically contemplates combination of both a TE system 450 and an AAF system 410, wherein the heat from the TE system 450 hot side heat sink 481, (which is normally wasted energy that must be removed from the produce chamber 100), be used to heat the AAF system 410 boiler 420. By using what would normally be wasted heat from the TE system 450 to drive the AAF system 410, the overall efficiency of the produce chamber 100 is dramatically increased.

### The Controller and Scrubber

The controller 500 is best illustrated in FIG. 5. There are three primary functions of the controller 500 contemplated by the invention. First, the controller 500 constantly monitors the temperature and humidity within the produce chamber 100. Such information may be displayed by a digital readout 510 positioned and located on the first panel 210. Second, the controller 500 operates the refrigeration system 400. Such operation may include determining when to turn on the AAF system 410 and/or the TE system 450.

As a third duty, the controller 500 can also opt to circulate already cooled air within the produce chamber through a scrubber 490—for purposes of removing toxins such as ethylene which may lead to premature ripening of the fruits and vegetables contained within the produce chamber 100. Although a variety of scrubbers 490 known to those of ordinary skill may be used, the invention specifically contemplated use of a zeolite filter 491. Such zeolite filter 491 should include a sufficient amount of a crystalline zeolite powder 492 capable of removing ethylene from the air within the produce chamber 100.

We claim:

1. A produce chamber, comprising:
an outer housing having a first panel, a second panel, and a base plate inter-dispersed between the first and second panels;
a door positioned between the first panel and the second pane, wherein the door is capable of opening to deposit and remove various produce;
a refrigeration system stored within the outer housing, wherein the refrigeration system includes an ammonium absorption (AAF) system; and
a controller capable of operating the refrigeration system.

2. The produce chamber of claim 1, wherein the first panel includes a circular disk having a ring, a first wall, and a flat bottom portion which mirrors the width of the base plate.

3. The produce chamber of claim 2, wherein the first panel further includes a series of vents sufficient for permitting cooling of the refrigeration system.

4. The produce chamber of claim 1, wherein the door comprises a transparent portion and includes a handle.

5. The produce chamber of claim 1, wherein the ammonium absorption system includes a contact plate which communicates with a series of ducts having a first channel and a corresponding second channel, and wherein the first channel circulates a quantity of ammonia and the second channel draws and then cools outside air for introduction into the produce chamber.

6. The produce chamber of claim 5, wherein a Peltier effect thermoelectric (TE) system is positioned proximate the contact plate to afford additional cooling, wherein the thermoelectric (TE) system includes a plurality of thermoelectric plates in parallel relation to one another.

7. The produce chamber of claim 6, wherein the controller includes a digital readout.

8. The produce chamber of claim 1, further comprising a scrubber which includes a quantity of crystalline zeolite powder capable of removing ethylene from air within the produce chamber.

9. A produce chamber, comprising:
an outer housing having a door;
a refrigeration system contained within the outer housing, the refrigeration system including an ammonium absorption (AAF) system;
a scrubber that includes a quantity of zeolite;
a controller operable with the refrigeration system and the scrubber.

10. The produce chamber of claim 9, wherein the outer housing includes a first panel, a second panel, and a base plate inter-dispersed between the first and second panels.

11. The produce chamber of claim 10, wherein the first panel includes a circular disk having a ring, a first wall, and a flat bottom portion which mirrors the width of the base plate.

12. The produce chamber of claim 11, wherein the first panel further includes a series of vents permitting cooling of the refrigeration system.

13. The produce chamber of claim 9, wherein the door comprises a transparent portion and includes a handle.

14. The produce chamber of claim 9, wherein the ammonium absorption system includes a contact plate which communicates with a series of ducts having a first channel and a corresponding second channel, and wherein the first channel circulates a quantity of ammonia and the second channel draws and then cools outside air for introduction into the produce chamber.

15. The produce chamber of claim 14, wherein a Peltier effect thermoelectric (TE) system is positioned proximate the contact plate to afford additional cooling, wherein the thermoelectric (TE) system includes a plurality of thermoelectric plates in parallel relation to one another.

16. The produce chamber of claim 15, wherein the controller includes a digital readout.

17. A produce chamber, comprising:
an outer housing having a door;
a refrigeration system positioned within the outer housing, the refrigeration system including an ammonium absorption (AAF) system that includes a contact plate which communicates with a series of ducts having a first channel and a corresponding second channel, wherein the first channel circulates a quantity of ammonia and the second channel draws and then cools outside air for introduction into the outer housing;
a controller capable of operating the refrigeration system.

18. The produce chamber of claim 17, wherein a Peltier effect thermoelectric (TE) system is positioned proximate the contact plate to afford additional cooling, wherein the thermoelectric (TE) system includes a plurality of thermoelectric plates in parallel relation to one another.

19. The produce chamber of claim 17, further comprising a scrubber which includes a quantity of crystalline zeolite powder capable of removing ethylene from air within the produce chamber.

20. The produce chamber of claim 17, wherein the outer housing includes a first panel, a second panel, and a base plate inter-dispersed between the first and second panels; such first panel further including a circular disk having a ring, a first wall, and a flat bottom portion which mirrors the width of the base plate, and wherein the first panel further includes a series of vents capable of cooling the refrigeration system.
